(19) United States
(12) Patent Application Publication
(10) Pub. No.: US 2011/0110306 A1
(43) Pub. Date: May 12, 2011

(54) NETWORK SYSTEM, MOBILE GATEWAY, LOCATION MANAGEMENT SERVER, AND COMMUNICATION CONTROL METHOD OF MOBILE NODE

(76) Inventor: Kenichi Yajima, Tokyo (JP)

(21) Appl. No.: 12/999,968

(22) PCT Filed: Jun. 29, 2009
(86) PCT No.: PCT/JP2009/061858

§ 371 Date: Dec. 17, 2010

(30) Foreign Application Priority Data
Jun. 30, 2008 (JP) 2008-170911

(51) Int. Cl. H04W 4/00

(52) U.S. Cl. 370/328

(57) ABSTRACT

In a network system that communicates with a mobile node, optimization of a communication route between the mobile node and its communication partner is realized while suppressing modifications of the mobile node, the communication partner of the mobile node, and devices constituting a network. A mobile gateway includes a communication monitor unit that monitors the communication status of a mobile node that is a management target to acquire data indicating the communication status; a mobile processing unit that registers location information of the mobile node with a location management server and forwards a message between the mobile node and the location management server; a home network modification report unit that generates a modification request to a new routing table in which a forwarding destination of a message destined to a home address of the mobile node is modified, if the data indicating the communication status exceeds a threshold value; and a routing management unit that receives the modification request and reports the new routing table to a router.

### TECHNICAL FIELD

The present invention relates to a network system that communicates with a mobile node, a mobile gateway and a location management server of such a network system, and a communication control method of a mobile node.

### BACKGROUND ART

As a network system that communicates with a mobile node, Patent Document 1 has In proposed a location information management system in which a gateway is provided at the border of a mobile IP network, and the gateway retains and manages information that is the same as location information managed by all home agents in the mobile IP network together, thereby realizing route optimization.

Moreover, Patent Document 2 has proposed the following wireless communication system. Before moving, a mobile terminal transmits a location pre-registration message, which includes a care-of address to be used at a moving destination and a home address of the mobile terminal, to a communication partner terminal through an access router to which the mobile terminal is currently connected. After moving, the mobile terminal creates a packet destined to the communication partner terminal by using the care-of address transmitted through the location pre-registration message, and then transmits the created packet. Upon receipt of the location pre-registration message, the communication partner terminal creates and stores the correspondence relationship between the care-of address of the mobile terminal after moving and the home address based on the location pre-registration message. Subsequently, if the movement of the mobile terminal is detected, the communication partner terminal updates the correspondence relationship between a current care-of address and the home address by using the stored correspondence relationship, creates a packet destined to the mobile terminal by using the updated correspondence relationship, and then transmits the packet. By doing as described above, the communication partner terminal can start communication with the mobile terminal on the optimal route without passing through a home agent.

Furthermore, Patent Document 3 has proposed a mobile node and a mobile communication method which modify a present home agent to be a nearer home agent when the distance between the mobile node and the home agent is far, thereby reducing the load on a network and decreasing a delay of data.

### PRIOR ART DOCUMENT

### Patent Document

Patent Document 1: Japanese Unexamined Patent Application, First Publication No. 2001-168906
Patent Document 2: Japanese Unexamined Patent Application, First Publication No. 2007-96932
Patent Document 3: Japanese Unexamined Patent Application, First Publication No. 2004-7578

### DISCLOSURE OF THE INVENTION

### Problems to be Solved by the Invention

However, in the above-described network system disclosed in Patent Document 1, which communicates with the mobile node, there is a problem in that it is difficult to improve a communication route between the mobile node and a communication partner without adding functions to the mobile node, the communication partner, and a network device not participating in the mobility support of the mobile node, and without modifying the home address or the like of the mobile node.

In Patent Document 2, in order to improve a communication route between the mobile terminal (a mobile node) and the communication partner terminal, it is necessary to add functions to an access router to which the communication partner terminal and the mobile node are connected.

Furthermore, in Patent Document 3, in order to improve a communication route, it is necessary to modify the home address of the mobile node. In addition, when the home address is to be modified, it is necessary to complete a connection-type communication before the modification, and then perform a reconnection.

In order to solve the above-described problems, an object of the present invention is to provide a network system, a mobile gateway, a location management server, and a Communication control method of a mobile node that are capable of optimizing a communication route between a mobile node and its communication partner while suppressing modifications of the mobile node, the communication partner of the mobile node, and devices constituting a network.

### Means for Solving the Problems

In view of the foregoing problems, a network system of the present invention includes: a mobile node serving as a communication device that performs movement; a location management server that receives a message destined to the mobile node by proxy, and performs a transmission process; a router that forwards the message with reference to a retained routing table; and a mobile gateway that registers location information of the mobile node with the location management server on behalf of the mobile node, performs transmission and reception of a message with the location management server, monitors the communication status of the mobile node to acquire data indicating the communication status, and reports a new routing table in which a forwarding destination of a message destined to a home address of the mobile node is modified to the router when the data exceeds a threshold value.

A mobile gateway of the present invention includes: a communication monitor unit that monitors the communication status of a mobile node that is a management target to acquire data indicating the communication status; a mobile processing unit that registers location information of the mobile node with a location management server and forwards a message between the mobile node and the location management server; a home network modification report unit that generates a modification request to a new routing table in which a forwarding destination of a message destined to a home address of the mobile node is modified, if the data indicating the communication status exceeds a threshold value; and a routing management unit that receives the modification request and reports the new routing table to a router.

A location management server of the present invention includes: an agent processing unit that stores location information of a mobile node, receives a message destined to the mobile node by proxy, and forwards the message with a mobile gateway; a routing management unit that exchanges a routing table with a router, stores the routing table, and performs a transmission process of a message in accordance with the stored routing table; and a home network modification unit that monitors the routing table stored in the routing management unit, confirms whether or not there exists a modification of a routing table associated with a home network of the mobile node, and modifies the home network of the mobile node when the modification exists.

A communication control method of a mobile node of the present invention includes: monitoring the communication status of the mobile node that is a management target of a mobile gateway to acquire data indicating the communication status; and when the data exceeds a threshold value, reporting a new routing table in which a forwarding destination of a message destined to a home address of the mobile node is modified to a router.

### Effect of the Invention

In accordance with the present invention, a mobile gateway monitors the communication status of a mobile node and modifies a forwarding destination of a message destined to a home address of the mobile node with respect to a routing table exchanged among routers in a network, so that optimization of a communication route between the mobile node and a communication partner can be realized. At this time, the only network devices which need to be modified are a location management server and a mobile gateway. Consequently, it is possible to improve the communication route between the mobile node and the communication partner without adding functions to the mobile node, the communication partner, and a network device not participating in the mobility support of the mobile node, and without modifying the home address or the like of the mobile node.

Furthermore, in accordance with the present invention, the communication route between the mobile node and the communication partner is optimized, so that a message between the mobile node and the communication partner does not pass through a tunnel between the location management server and the mobile gateway, as well as the location management server. In addition, since the mobile node has moved to a home link, there is no mobility-related control message which is periodically transmitted to the location management server by the mobile gateway. Consequently, it is possible to reduce the load caused by an encapsulation process of a packet in the location management server and the mobile gateway and exchange of a mobility-related control message (a location registration message and a location response message).

### BRIEF DESCRIPTION OF THE DRAWINGS

FIG. 1 is a block diagram showing the configuration of a network system in accordance with a first exemplary embodiment of the present invention.

FIG. 2 is a functional block diagram showing the configuration of a mobile gateway in a first exemplary embodiment of the present invention.

FIG. 3 is a functional block diagram showing the configuration of a location management server in a first exemplary embodiment of the present invention.

FIG. 4A is a diagram explaining a routing table provided in a router of a network in a first exemplary embodiment of the present invention.

FIG. 4B is a diagram explaining a routing table provided in a router of a network in a first exemplary embodiment of the present invention.

FIG. 5 is a sequence diagram used for explaining an optimization process of a communication route in a first exemplary embodiment of the present invention.

FIG. 6 is a block diagram showing the configuration of a network system in accordance with a second exemplary embodiment of the present invention.

FIG. 7 is a block diagram showing the configuration of a network system in accordance with a third exemplary embodiment of the present invention.

### MODE FOR CARRYING OUT THE INVENTION

Hereinafter, exemplary embodiments of the present invention will be described in detail with reference to the drawings.

### First Exemplary Embodiment

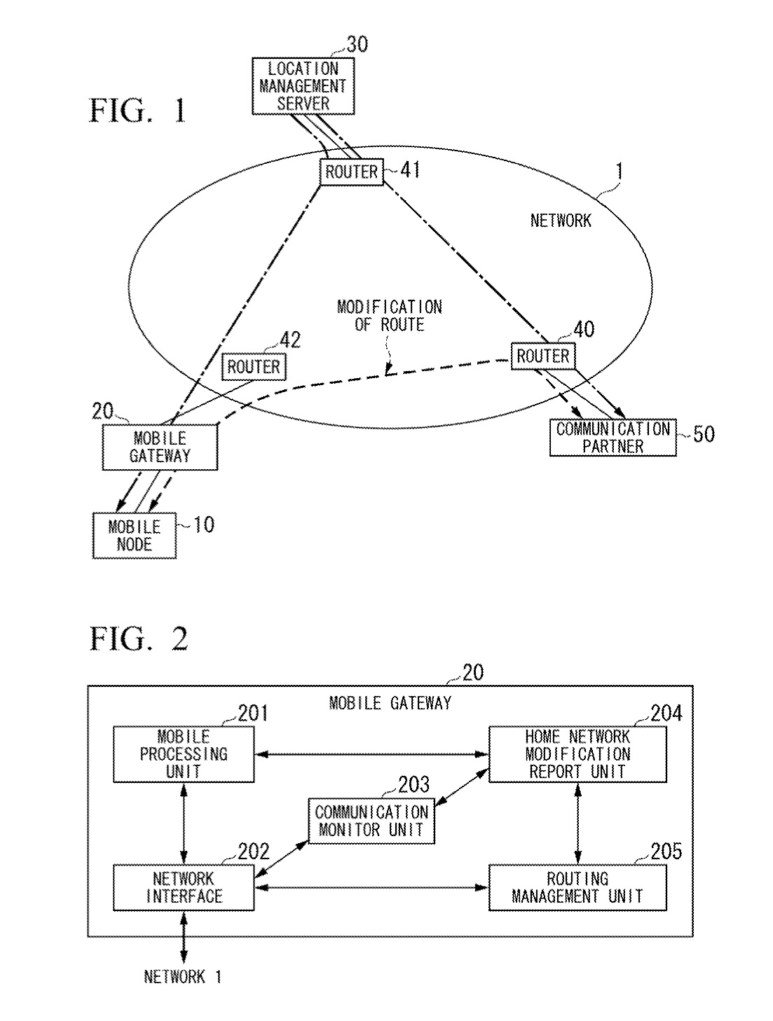

FIG. 1 shows an example of the configuration of a network system in accordance with the first exemplary embodiment of the present invention. Each device shown in FIG. 1 will be described below.

The network system shown in FIG. 1 includes a mobile node 10, a mobile gateway 20, a location management server 30, a network 1, and a communication partner 50. The mobile node 10 is a communication device which performs movement. The mobile gateway 20 is a router which registers location information of the mobile node 10 with the location management server 30 on behalf of the mobile node 10 that is a management target, and creates a tunnel with the location management server 30. The location management server 30 stores the location information of the mobile node 10, receives a message destined to the mobile node 10 by proxy, and performs a transmission process. The network 1 is configured by routers 40, 41, and 42, and the like. Each of the routers 40, 41, and 42 retains a routing table and forwards a message with reference to the routing table. The communication partner 50 is a communication partner of the mobile node 10 and is a device such as a personal computer.

FIG. 2 shows the configuration of the mobile gateway 20. Hereinafter, each unit shown in FIG. 2 will be described below.

A mobile processing unit 201 performs processes of registering the location information of the mobile node 10 with the location management server 30 on behalf of the mobile node 10, of encapsulating a message from the mobile node 10 and forwarding the encapsulated message to the location management server 30, of decapsulating an encapsulated message transmitted from the location management server 30 and forwarding the decapsulated message to the mobile node 10, and of storing address information of the mobile node 10.

A network interface 202 is connected to the network 1 to perform transmission and reception of messages.

A communication monitor unit 203 monitors messages transmitted and received through the network interface 202, acquires data indicating the communication status (the communication state), such as duration of communication of a mobile node, and stores the data.

A home network modification report unit 204 determines that the home network of the mobile node is to be modified with reference to the state of the mobile node which is stored in the communication monitor unit 203, and performs the modification.

A routing management unit 205 exchanges a routing table with the router 41 and stores the routing table, and forwards messages which are received from other communication devices in accordance with the stored routing table.

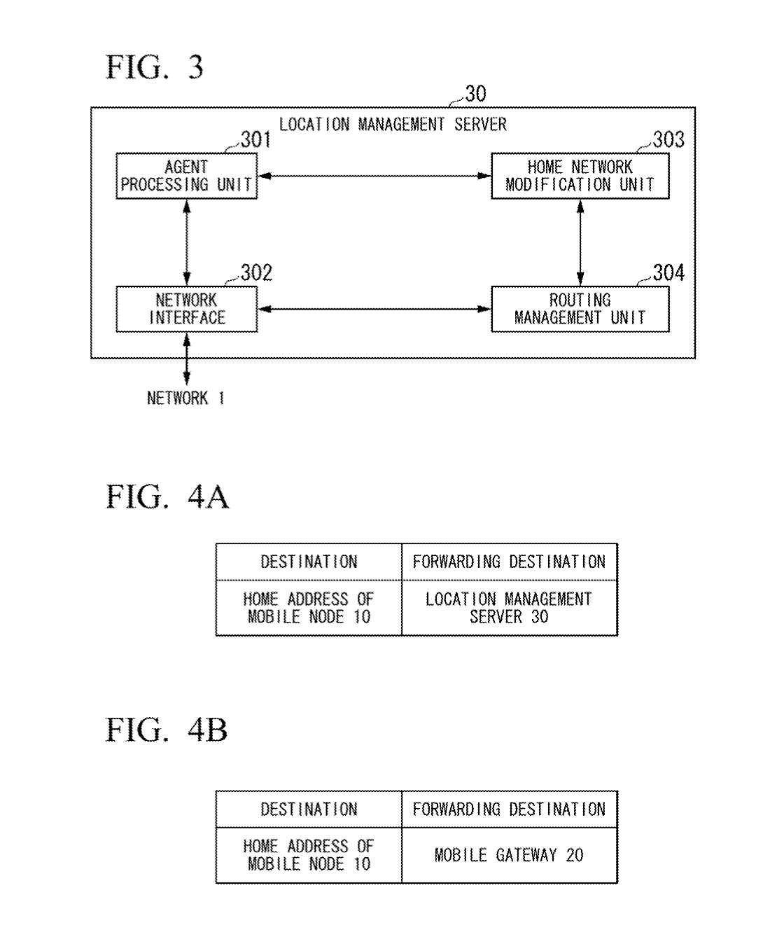

FIG. 3 shows the configuration of the location management server 30. Hereinafter, each unit shown in FIG. 3 will be described below.

An agent processing unit 301 performs processes of storing the location information of the mobile node 10, of receiving the message destined to the mobile node 10 by proxy, encapsulating a message to the mobile node 10 and forwarding the encapsulated message to the mobile gateway 20, of decapsulating an encapsulated message transmitted from the mobile gateway 20 and forwarding the decapsulated message, and of storing information on the addresses of the mobile node 10 and the mobile gateway 20.

A network interface 302 is connected to the network 1 to perform transmission and reception of messages.

A home network modification unit 303 monitors a routing table stored in a routine management unit 304 which will be described later, and confirms whether or not there exists a modification of a routing table associated with the home network of the mobile node 10. When the modification exists, the home network modification unit 303 modifies the home network of the mobile node 10.

The routing management unit 304 exchanges a routing table with other routers and stores the routing table, and forwards messages which are received from other communication devices in accordance with the stored routing table.

Next, the operation of the first exemplary embodiment of the present invention will be described. In an initial state, the mobile node 10 is attempting to connect to the mobile gateway 20.

In FIG. 1, if the mobile node 10 is connected to the mobile gateway 20, the mobile processing unit 201 (FIG. 2) of the mobile gateway 20 transmits a registration message to the location management server 30 through the network interface 202 in order to register the home address of the mobile node 10 and the address of the mobile gateway 20 with the location management server 30.

Upon, receipt of the registration message through the network 1, the network interface 302 (FIG. 3) of the location management server 30 passes the message to the agent processing unit 301. The agent processing unit 301 stores information on the home address of the mobile node 10 and the address of the mobile gateway 20, and transmits a registration response message to the mobile gateway 20 through the network interface 302.

If the network interface 202 of the mobile gateway 20 receives the registration response message through the network 1, the network interface 202 reports the registration response message to the mobile processing unit 201. The mobile processing unit 201 having received this message creates a tunnel with the location management server 30.

In this state, the routers 40 to 42 existing in the network 1 include routing tables, in accordance with which a message including the address destined to the mobile node 10 is to be forwarded to the location management server 30, as shown in FIG. 4A. If a message destined to the mobile node 10 is transmitted from the communication partner 50, the message reaches the router 40. The router 40 confirms that a message destined to the home address of the mobile node 10 is to be transmitted to the location management server 30 with reference to the routing table stored in the router 40 itself, and forwards the message received from the communication partner 50 toward the location management server 30. This message is forwarded in accordance with the routing tables stored in routers of the network 1 and reaches the network interface 302 of the location management server 30.

The network interface 302 forwards the received message to the agent processing unit 301. The agent processing unit 301 confirms a table of the mobile node 10 with reference to tables of location information registered in the agent processing unit 301 itself, and encapsulates the message. Then, the agent processing unit 301 transmits the encapsulated message toward the mobile gateway 20 registered in the table through the network interface 302.

The encapsulated message reaches the network interface 202 of the mobile gateway 20 through the network 1. The network interface 202 forwards the encapsulated message to the mobile processing unit 201. The mobile processing unit 201 decapsulates the encapsulated message and transmits the decapsulated message toward the mobile node 10 through the network interface 202. The message reaches the mobile node 10.

A message transmitted toward the communication partner 50 from the mobile node 10 is processed in a similar manner through a reverse communication route to the above-described communication route.

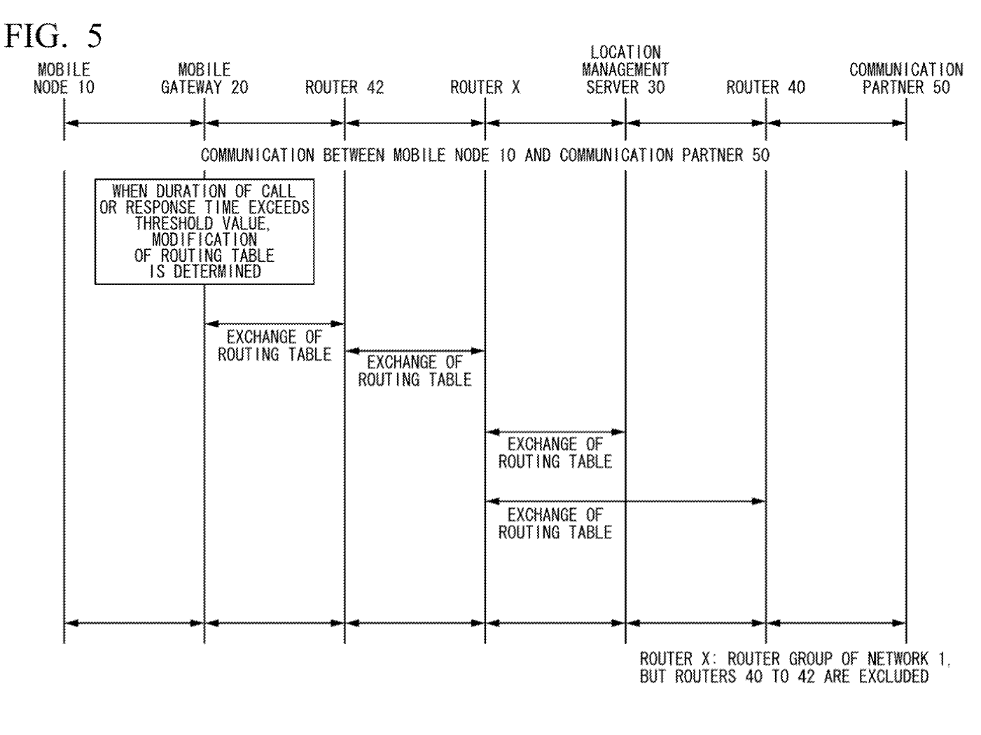

Next, in this state, an operation when optimizing the communication route between the mobile node 10 and the communication partner 50 will be described. FIG. 5 shows a sequence when performing an optimization process.

The home network modification report unit 204 of the mobile gateway 20 monitors the communication status (duration of communication, a response time from the communication partner 50, or the like) of the mobile node 10, and acquires data indicating the communication status. For example, when the connection time of the mobile node 10 exceeds a previously specified threshold value or when the response time until a response is received after the mobile node 10 transmits a message to the communication partner 50 exceeds a previously specified threshold value, the home network modification report unit 204 determines that the home network of the mobile node 10 is to be modified. When modifying the home network, the home network modification report unit 204 generates a modification request to a new routing table in which a forwarding destination of a message destined to the home network address of the mobile node 10 is modified to be the mobile gateway 20 itself, and reports the modification request to the routing management unit 205. The routing management unit 205 having received the report of the modification request reports the new routing table to a neighbor router. Furthermore, with a routing modification, the home network modification report unit 204 performs processes of forwarding a message destined to the mobile node 10 to the location management server 30 and of stopping a control message.

The new routing table is reported to the routers 40 to 42 existing in the network 1 through a routing protocol. FIG. 4B shows the new routing table at this time. As shown in FIG. 4B, in accordance with the new routing table, the forwarding destination of the message including the address destined to the mobile node 10 is modified to be the mobile gateway 20.

If the new routing table is reported from the router 41, the routing management unit 304 of the location management server 30 modifies a routing table. The home network modification unit 303 monitoring the modification of the routing table confirms whether or not a routing modification has been performed with respect to a mobile node which performs mobility support by itself. When the routing modification has been performed, the home network modification unit 303 performs processes of deleting a binding cache of the mobile node and of stopping relaying communication between the mobile node 10 and the communication partner 50. That is, the home network modification unit 303 compares a home address stored in the modified routing table as a destination with a home address with which location-registration was performed previously, and when these home addresses coincide with each other, the location registration of the mobile node is deleted. Furthermore, with the modification of the routing table, the home network modification unit 303 stops the mobility support of the mobile node (forwarding of a packet destined to the mobile node and a response to the location registration of the mobile node).

Here, when a message is transmitted from the communication partner 50 to the mobile node 10, the following processes are performed.

The message destined to the mobile node 10 transmitted from the communication partner 50 reaches the router 40. The router 40 transmits the message, which has been transmitted from the communication partner 50, toward the mobile gateway 20 serving as a forwarding destination of the message destined to the mobile node 10 with reference to its own routing table.

The message reaches the network interface 202 of the mobile gateway 20 through the network 1. The network interface 202 forwards the message toward the adjacent mobile node 10. The message reaches the mobile node 10.

When a message destined to the communication partner 50 is transmitted from the mobile node 10, similar processes are performed through a reverse route to the above-described route, so that the message reaches the communication partner 50.

As described above, in accordance with the first exemplary embodiment of the present invention, the mobile gateway 20 monitors the communication status such as duration of communication of the mobile node 10 and the response time from the communication partner. When data indicating the communication status exceeds the previously specified threshold value, the routing table associated with the home address of the mobile node 10 is modified among the routing tables stored in the routers 40 to 42 in the network 1. Consequently, a modification of a home link of the mobile node 10 is realized, so that optimization of a communication route between the mobile node 10 and the communication partner can be realized.

### Second Exemplary Embodiment

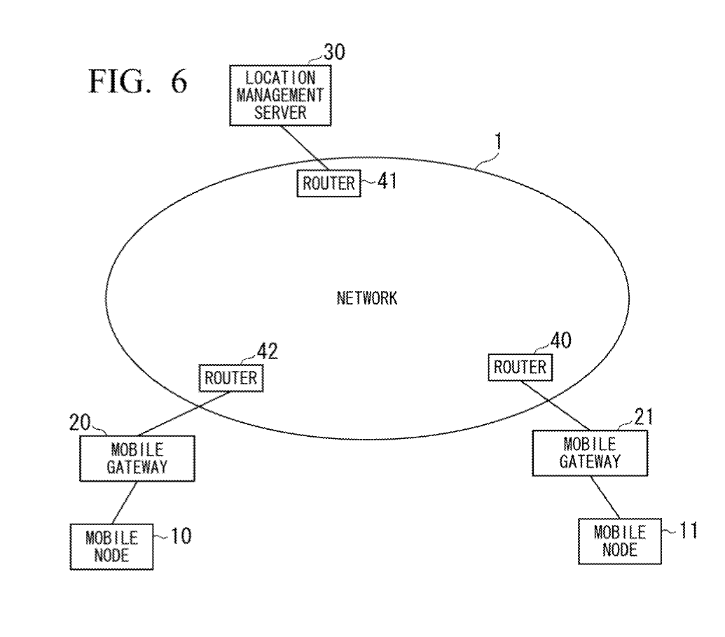

Next, a second exemplary embodiment of the present invention will be described. FIG. 6 shows the second exemplary embodiment of the present invention.

The difference between the second exemplary embodiment and the first exemplary embodiment is that, in the second exemplary embodiment, the communication partner 50 is a movable mobile node 11 and a mobile gateway 21 is additionally provided. The mobile gateway 21 registers location information of the mobile node 11 with the location management server 30.

If the first exemplary embodiment were directly applied to the configuration of FIG. 6, the location information of the mobile node 11 remains registered in the location management server 30. As a result, when the communication partner of the mobile node 10 is the mobile node 11, communication between the mobile node 10 and the mobile node 11 is always performed through the location management server 30, thereby a communication route is lengthened.

In contrast, in accordance with the second exemplary embodiment, the mobile gateway 21 is additionally provided, and the mobile gateway 21 and the location management server 30 operate in a similar manner with respect to the mobile node 11, which is a communication partner of the mobile node 10, similarly to the way that the mobile gateway 20 and the location management server 30 operate with respect to the mobile node 10. Thus, a message destined to the mobile node 10 is forwarded toward the mobile gateway 20. Furthermore, a message destined to the mobile node 11 is forwarded toward the mobile gateway 21. As a result, a communication route between the mobile node 10 and the mobile node 11 does not pass through the location management server 30, so that communication on the optimal route is possible.

### Third Exemplary Embodiment

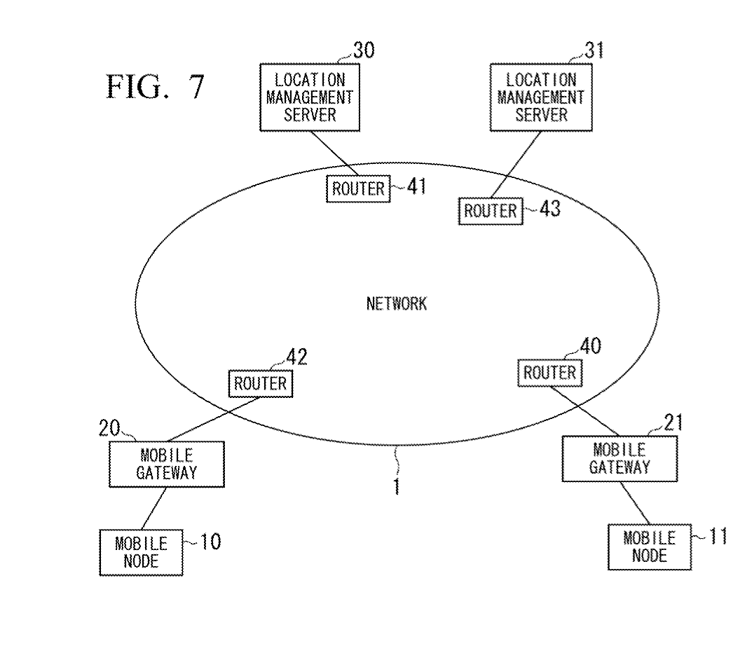

Next, a third exemplary embodiment of the present invention will be described. FIG. 7 shows the third exemplary embodiment of the present invention.

The difference between the third exemplary embodiment and the second exemplary embodiment is that a registration target of the location information of the mobile node 11 is not the location management server 30 but a location management server 31 which is connected to the network 1 through a router 43.

The operation of the third exemplary embodiment is identical to that of the second exemplary embodiment, except that the registration target of the location information is not the location management server 30 but the location management server 31.

In the third exemplary embodiment as well, since a communication route between the mobile node 10 and the mobile node 11 does not pass through the location management server 30, communication on the optimal route is possible.

While the present invention has been particularly shown and described with reference to exemplary embodiments thereof, the present invention is not limited to those exemplary embodiments. It will be understood by those of ordinary skill in the art that various changes in form and details may be made therein without departing from the spirit and scope of the present invention as defined in the claims.

It is noted that, in the present invention, before the modification of the forwarding destination, the location management server may be set in the routing table of the router as the forwarding destination of a message including an address destined to the mobile node, and if the data indicating the communication status exceeds the threshold value, the forwarding destination set in the routing table of the router may be modified to be the mobile gateway.

Moreover, the present invention may be provided with an additional mobile gateway corresponding to a mobile node which is a communication partner of the mobile node.

Moreover, the present invention may be provided with an additional location management server corresponding to a mobile node which is a communication partner of the mobile node.

Moreover, in the present invention, if the data indicating the communication status exceeds the threshold value, the home network modification report unit may generate a modification request indicating that the forwarding destination of the message destined to the home address of the mobile node is to be modified to be the mobile gateway itself.

Moreover, in the present invention, the data indicating the communication status may include at least one of the connection time of the mobile node and the response time until a response is received after a message is transmitted to a communication partner of the mobile node.

Moreover, in the present invention, when the routing table associated with the home address of the mobile node has been modified, the home network modification unit may delete a binding cache of the mobile node and stop relaying communication between the mobile node and a communication partner of the mobile node.

This application is based upon and claims the benefit of priority from Japanese Patent Application No. 2008-170911, filed on Jun. 30, 2008, the disclosure of which is incorporated herein in its entirety by reference.

### INDUSTRIAL APPLICABILITY

In accordance with the present invention, it is possible to improve a communication route between a mobile node and a communication partner without adding functions to the mobile node, the communication partner, and a network device not participating in the mobility support of the mobile node, and without modifying the home address or the like of the mobile node. Furthermore, it is possible to reduce the load caused by a packet encapsulation process in a location management server or a mobile gateway and exchange of a mobility-related control message (a location registration message and a location response message).

### DESCRIPTION OF REFERENCE NUMERALS

1 Network
10, 11 Mobile node
Mobile gateway
20, 21 Mobile gateway
30, 31 Location management server
40 to 43 Router
50 Communication partner
201 Mobile processing unit
202 Network interface
203 Communication monitor unit
204 Home network modification report unit
205 Routing management unit
301 Agent processing unit
302 Network interface
303 Home network modification unit
304 Routing management unit

1. A network system comprising:
a mobile node serving as a communication device that performs movement;
a location management server that receives a message destined to the mobile node by proxy, and performs a transmission process;
a router that forwards the message with reference to a retained routing table; and
a mobile gateway that registers location information of the mobile node with the location management server on behalf of the mobile node, performs transmission and reception of a message with the location management server, monitors the communication status of the mobile node to acquire data indicating the communication status, and reports a new routing table in which a forwarding destination of a message destined to a home address of the mobile node is modified to the router when the data exceeds a threshold value.

2. The network system according to claim 1, wherein, before the forwarding destination is modified, the location management server is set in the routing table of the router as a forwarding destination of a message including an address destined to the mobile node, and the forwarding destination set in the routing table of the router is modified to be the mobile gateway if the data indicating the communication status exceeds the threshold value.

3. The network system according to claim 1, comprising an additional mobile gateway corresponding to a mobile node which is a communication partner of the mobile node.

4. The network system according to claim 1, comprising an additional location management server corresponding to a mobile node which is a communication partner of the mobile node.

5. A mobile gateway comprising:
a communication monitor unit that monitors the communication status of a mobile node that is a management target to acquire data indicating the communication status;
a mobile processing unit that registers location information of the mobile node with a location management server and forwards a message between the mobile node and the location management server;
a home network modification report unit that generates a modification request to a new routing table in which a forwarding destination of a message destined to a home address of the mobile node is modified, if the data indicating the communication status exceeds a threshold value; and
a routing management unit that receives the modification request and reports the new routing table to a router.

6. The mobile gateway according to claim 5, wherein, if the data indicating the communication status exceeds the threshold value, the home network modification report unit generates the modification request indicating that the forwarding destination of the message destined to the home address of the mobile node is to be modified to be the mobile gateway itself.

7. The mobile gateway according to claim 5, wherein the data indicating the communication status includes at least one of a connection time of the mobile node and a response time until a response is received after a message is transmitted to a communication partner of the mobile node.

8-9. (canceled)

10. A communication control method of a mobile node, comprising:
monitoring the communication status of the mobile node that is a management target of a mobile gateway to acquire data indicating the communication status; and
when the data exceeds a threshold value, reporting a new routing table in which a forwarding destination of a message destined to a home address of the mobile node is modified to a router.

11. The network system according to claim 2, comprising an additional mobile gateway corresponding to a mobile node which is a communication partner of the mobile node.

12. The network system according to claim 2, comprising an additional location management server corresponding to a mobile node which is a communication partner of the mobile node.

13. The network system according to claim 3, comprising an additional location management server corresponding to a mobile node which is a communication partner of the mobile node.

14. The network system according to claim 11, comprising an additional location management server corresponding to a mobile node which is a communication partner of the mobile node.

15. The mobile gateway according to claim 6, wherein the data indicating the communication status includes at least one of a connection time of the mobile node and a response time until a response is received after a message is transmitted to a communication partner of the mobile node.
